(19) United States
(12) Patent Application Publication
(10) Pub. No.: US 2011/0262884 A1
(43) Pub. Date: Oct. 27, 2011

(54) Soft tissue models and method of making for dental implant applications

(76) Inventors: Robert Zena, Louisville, KY (US); Sarah Johnson, Louisville, KY (US)

(21) Appl. No.: 13/066,353

(22) Filed: Apr. 13, 2011

Related U.S. Application Data
(63) Continuation-in-part of application No. PCT/US2009/006087, filed on Nov. 13, 2009.
(60) Provisional application No. 61/199,160, filed on Nov. 13, 2008.

(51) Int. Cl. A61C 8/00

(52) U.S. Cl. 433/201.1

(57) ABSTRACT

The present invention relates to laboratory components that are used in the field of dental prosthesis and for dental implant fabrication and in particular to a spacer means such as a band, ring, or sleeve forming a soft collar which slips over the analog and slides up to the base of the set impression material near the collar of the impression coping as it emerges through the impression forming a uniform blockout around the impression coping which is recording the sub-gingival space over the top of the fixture and having a soft collar surrounding the neck of the analog insulates the top of the fixture analog from the hard stone where it couples with other components. The spacer forming the soft collar is particularly useful for orienting and indexing the modeling of dental implant restorations and to enhance and improve the fabrication process of soft tissue type models for conventional restoration techniques. It also enhances model techniques for digital scanning of cases in the laboratory. The soft collar spacer means forms a uniform blockout around the impression coping which is recording the sub-gingival space over the top of the fixture.

### RELATED APPLICATIONS

This application is a continuation in part and claims priority from PCT application PCT/US2009/006087 filed on Nov. 13, 2009 claiming priority from U.S. provisional application Ser. No. 61/199,160 filed on Nov. 13, 2008 all of which are hereby incorporated by reference in their entirety.

### TECHNICAL FIELD OF THE INVENTION

The present invention relates to laboratory components that are used in the field of dental prosthesis and for dental implant fabrication and in particular to a spacer means such as a band, ring, or sleeve forming a soft collar which slips over the analog and slides up to the base of the set impression material near the collar of the impression coping as it emerges through the impression forming a uniform blockout around the impression coping which is recording the sub-gingival space over the top of the fixture and having a soft collar surrounding the neck of the analog insulates the top of the fixture analog from the hard stone where it couples with other components.

### BACKGROUND OF THE INVENTION

The analogic concept described is related to the dental profession, with special regard to model fabrication for dental implant restorations. Its function is to enhance and drastically improve the fabrication process of soft tissue type models. The soft tissue model not only enhances model fabrication for conventional techniques and provides a method of indexing with a removal soft collar, but it also enhances model techniques for digital scanning of cases in the laboratory.

Before one can understand the basis of this new soft issue model and method of making, it is important to have an understanding for the basic fundamentals of the conventional fabrication methods for creating impressions and soft tissue models of the impressions on implant patients.

There are numerous patents relating to the design and method of installation various implants.

For instance, U.S. Pat. No. 5,934,906 by Phimmasone issued in August of 1999 and teaches a model for prosthodonitic preparation of a tooth for installation of a clinical crown for attachment on an implant fixture and describes a type of analog on which the crown can be mounted during preparation and is incorporated by reference in that it teaches analogs which could be used with the instant invention.

U.S. Pat. No. 6,280,195 by Broberg et al. issued Aug. 28, 2001 teaches a method for treating a partially or totally edentulous patient by fabricating dental implants using a soft tissue model wherein the technician paints the area around the impression coping with a soft rubbery material prior to pouring the impression. This soft tissue process is disadvantageous in that it is messy, time consuming, difficult to control, difficult to standardize, and difficult to reproduce. In addition, it is not repeatable in that, a technician will not be able to paint the material on in the same thickness or in the same area each time.

U.S. Pat. No. 7,018,207 by Prestipino issued Mar. 28, 2006 presents a dental implant analog having a circumferential retention groove which provides a rib created in the soft tissue painted around the impression coping. This in turn provides registration of the analog within the poured impression. The idea of registration of the analog is advantageous but is limited to use of a particular type of analog and is incorporated by reference herein as an example of an implant adaptable for use with the instant invention.

Before one can understand the basis of this new soft issue model and method of making, it is important to have an understanding for the basic fundamentals of the conventional fabrication methods for creating impressions and soft tissue models of the impressions on implant patients.

Dental restoration utilizing implants typically requires making an incision through the gingiva to expose the jaw bone. A dental implant used to replace the patient's tooth root. The dental implant is typically threaded into a bore formed in the jaw bone and undergoes integration. Thus, the implants (fixtures) 20 are surgically placed in the patient's bone 30 and allowed to heal for several weeks or months. Next, the surgeon uncovers the implant which is submerged under the soft tissues at bone level, and fastens a healing abutment to the exposed end of the dental implant allowing the gum tissue to heal. The healing abutment is usually a titanium abutment which is temporarily placed by the surgeon to communicate from the top of the submerged implant, thru the soft tissues and into the oral environment. When the restoring dentist goes to complete the restoration, the top of the healing abutment is readily visible and he or she has easy access to the top of the implant (fixture), submerged below the soft tissues. The impression coping typically has about the same gingival dimensions as the healing abutment to minimize the gap between the coping and the gum tissue. As described in the aforementioned references, the impression coping may be a pickup type impression coping, a transfer type impression coping, or other embodiments thereof known in the art.

In order to fabricate a crown or restoration onto the implant the dentist must make a model which represents an exact copy of the patient's mouth. A prosthesis is created to be permanently secured to the dental implant from the impression. The first step in this process is to remove the healing abutment 1 as shown in FIG. 1. It is then replaced with an impression/transfer coping 10 as illustrated in FIG. 2 whereby the healing cap 1 is removed and replaced with the impression/transfer coping 10 which is screwed to the top of the fixture 20.

As shown in FIG. 3, an impression is made of the mouth with this coping 10 in place. It is important to insure that impression/transfer coping 10 does not hit the tray. Heavy body polyvinylsiloxane or similar material is typically utilized as the material to record the impression.

When the impression is removed the impression/transfer coping 10 records the orientation of the fixture 20 to the teeth as shown in FIG. 4. When the impression or impression tray is removed the transfer coping 10 stays in the mouth. This transfer coping 10 is actually a part of the set impression. The transfer coping 10 is then removed and replaced by the healing cap 1.

Next, the impression is normally sent to the laboratory, where a dental technician screws an implant replica (analog) 7 to the base of the impression transfer coping 10. This is nothing more than a dummy implant which is of the exact configuration and diameter of the actual fixture 20 as illustrated in FIG. 13 and is analogous to the dental implant that is located within the patient's mouth.

Dental stone or plaster is then poured into the impression to harden and produce a model which represents the patient's mouth. The problem with this conventional technique is that the implant replica analog 7 becomes imbedded completely in hard plaster or dental stone whenever the actual implant replica analog 7 sits a bit under the gum tissues. Then the model has a plaster or stone channel which leads down to the implant replica analog 7 which is totally embedded. This makes it difficult to approximate other components down in the channel and see around them in order to makes sure other parts are totally seated on the implant replica analog 7.

Therefore, it is desirable to fabricate a soft tissue model to represent the gingival tissue within the patients' mouth for use in the laboratory. This is done for several reasons, one is so that when restorative components are placed onto the new model which is made of hard plaster or stone they don't bind on the walls of the model and impede the parts from completely seating. The other reason is so that the contours of the gums can be preserved for orientation purposes. Moreover, the material is removable so the dental technician has access to the fixture head to be able to see that components are fully seated and they don't bind on the walls of plaster or stone.

The most common conventional soft tissue model technique employs a method whereby the technician paints or coats the area around the impression coping with a soft rubbery material prior to pouring the stone or plaster into the impression. The rubbery material typically projects through the impression material on the tissue side of the impression 50 and the top of the fixture analog 20 nearest the head. This facilitates the process when restorative components are placed onto the new model which is made of hard plaster or stone so that it does not bind on the walls of the model and impede the parts form completely seating. The down sides to this process are that it is crude and messy, time consuming, inexact and non-repeatable.

After the soft material sets, the technician pours the stone or plaster into the impression model and allows it to set. Upon removal, the cured impression comprises a two layered model. One layer is stone or plaster and the other which is closest to the implant is soft. This soft tissue model now has an implant replica analog 7 immersed in a stone cast with the soft tissue area around the implant reproduced in a soft rubbery material; this material also extends down around the head of the analog so there is no hard stone near the head of the analog. Removal of the impression material from the rubbery material and stone model the prosthesis can be formed o the implant analog. This rubbery material is removable and allows total access to all analogs when it is not in place. The problem other than being messy and laborious is that when the soft tissue portion of the model is removed, there is no way to approximate the soft tissues nearest the implant until the soft material is put back on the cast.

If one needs to visualize the sub-gingival contours of the prosthesis, the soft tissue “rubbery material” must be removed; however, reinstallation of the rubbery material onto the stone is inexact for there is no means for registering the location of the rubbery soft tissue model with the implant analog or stone model.

### SUMMARY OF THE INVENTION

A device for replacing conventional soft tissue models and method for making and using same is disclosed herein with respect to dental implant prosthesis fabrication and an implant analog used for supporting an article to develop a dental prosthesis. The analog provides a main body for being anchored in a model of a mouth of a patient. The main body includes an upper surface for contacting the article that is used to develop a dental prosthesis. The analog receives a soft modeling material that replicates gingival tissue. The known soft tissue model technique is a method whereby the technician paints the area around the impression coping with a soft rubbery material prior to pouring the impression. This facilitates the impression process when restorative components are placed onto the new model which is made of hard plaster or stone so that they don't bind on the walls of the model and impede the parts from completely seating, and allows for the dental technician to complete the restoration. The soft tissue collar composed of a soft polymeric material forming a ring or sleeve replaces the painting method and acts as an index. Moreover, the present invention provides a means such that the soft tissue sleeve or plug can be removed, and reseated back into the model in the same exact location thereby serving as a “standardized and indexable” soft tissue plug. The present invention replaces this method of painting the area around the coping with a polymeric material such as a plastisol, elastomer, or other plastic, or rubber material in the form of a ring, sleeve or other continuous strip of material fitting over the impression coping covering selected areas such as the top of the implant and/or the bottom of the analog. In addition, the present invention provides a more accurate method of indexing the analog and/or making a digital scan of a patient's dental situation as relates to dental implants.

Applicant's soft collar replaces the soft tissue model by simply pressing the sleeve or o-ring onto the analog before pouring the plaster or stone in the impression so upon curing the plaster is removed from the impression and the sleeve imbedded in the plaster around the analog can easily be removed to expose a small area around the analog. Indicia, or forming marks or projections in the sleeve and even shaping the sleeve provides numerous methods for indexing same to the analog.

Moreover, the present invention provides for a method for facilitating the fabrication of dental implant prosthesis is presented herein. The normal process of preparing the patient with an implant fixture in the bone and required healing are performed. An impression coping is installed in the fixture. An impression is made of the patients mouth. A technician must now prepare the impression for pouring with dental stone. First, he installs the impression coping with an implant analog (a replica of the implant in the jawbone) threadably connected thereto, into the hole left in the impression by the impression coping in the patient's mouth. At this point, he would paint a rubbery material around the impression coping to provide clearance in the stone impression. Instead, the present invention provides for the installation of a sleeve over the implant analog and down against the impression material. Now, the impression is ready to be poured with dental stone. When the stone has hardened, it is removed and is now referred to as the ‘master model’ or just the ‘model’. Because the implant analog is held within the hardened model, the coping comes out of the impression material because this material is fairly soft. At this point, the model has the coping sticking out of it and the sleeve is still in place around the junction of the coping and the implant fixture but is flush with the surface of the model. Now the technician can remove the coping and install an abutment onto which he will form the replacement tooth. He may remove the sleeve or replace it into the model as he wishes. This greatly aides the technician as he puts the tooth and abutment into and out of the model for test fitting, etc.

One preferred embodiment of this invention employs a sleeve which is initially soft so that when it is pressed into place over the implant and down against the impression material around the junction of the implant and coping, it takes on the random shape of the impression material at that sight. Next, the polymeric sleeve is irradiated with energy of some form (e.g. UV light, heat such as by microwaves, incandescent radiation, microwaves, or sound waves) to cure and/or cross-link the polymer forming the sleeve. Now the impression is ready to be poured with stone material. As in the paragraph above, the cured stone material (which is now called the ‘model’) is removed along with the coping and sleeve still in place in the model. The advantage with this sleeve is that it records the exact shape of the gum around the site of the implant. However, when the sleeve is removed, there is no easy way to reinstall it into the model with the correct angular orientation. In other words, the sleeve may be twisted around on the implant analog. Therefore, some way of registering the correct position of the sleeve with reference to the implant analog is needed. A sleeve outer wall can be formed in a selected shape such as an ovoid, tear drop, or other selected shape providing means of registering the sleeve back into the model. Moreover, the entire sleeve or sections or portions thereof can be color coded with regard to its dimension or thickness, (front, rear, left side, right side), to aid in repositioning the analog and quick selection of the appropriate sized spacer member.

Another approach used by dentists is to place a restorative type abutment (which is a abutment permanently installed in the mouth before the replacement tooth is made) in the implant in the patient's mouth and torque it so that it will not loosen. A snap-on impression cap is snapped over the permanent abutment before an impression is made. When the impression is removed, the snap-on impression cap, held firmly within the impression, snaps off the abutment. Now the technician snaps an abutment analog (replica) with an implant analog into the snap-on impression cap. At this point, he installs a soft collar formed by a ring or sleeve over the implant analog and down against the impression material as before.

It is an object of the present invention to provide an soft collar such as an o-ring or sleeve to replace the soft tissue model currently defining rubbery material painted around the base of the analog to leave an open area around the tope edge analog.

It is another object to replace the soft tissue rubbery material by simply

It is an object of this invention to provide a soft tissue modeling process which is a more exact, neater, and repeatable process.

It is also an object of this invention to provide a soft tissue modeling process which is neater and less time consuming, resulting in cost savings.

It is also an object of this invention to provide a method of accurately digitizing a dental stone impression and therefore an accurate representation of a patient's dental situation.

It is an object of the present invention to provide easy access for the dental technician to complete the restoration.

It is another object of the present invention to provide a means for indexing such that the soft tissue plug can be removed and reseated back into the model at the exact same location.

It is another object of the present invention to provide a means for creating standardized indexable soft tissue plugs.

It is another object of the present invention to provide a method of fabricating models for digital scanning of cases in the laboratory.

It is another object of the present invention to use the soft collar formed from the sleeve to expose an even deeper area around the analog in the plaster cast for ceralogic procedures.

Other objects, features, and advantages of the invention will be apparent with the following detailed description taken in conjunction with the accompanying drawings showing a preferred embodiment of the invention.

Thus, the present invention replaces this method of painting the area around coping with rubbery material by a process of placing an sleeve or flat ring down over the impression coping, and then pouring the impression. This is quick and easily repeatable. It is not messy and is exact due to the fact that sleeves and flat rings are made with tight tolerances and are therefore, in terms and tolerances of the dental implant process, identical to one another. They are also shaped so that they can be removed and replaced in exactly the same orientation every time, in other words, they are self aligning or self registering. When used in place of the rubbery material which is painted on, they provide spacing in the poured impression which gives the needed clearance and flexibility required in the implant fabrication and fitting process.

The analogic concept described is related to the dental profession, with special regard to model fabrication for dental implant restorations. Its function is to enhance and drastically improve the fabrication process of soft tissue type models. The soft tissue model not only enhances model fabrication for conventional techniques but also enhances model techniques for digital scanning of cases in the laboratory.

The analogic concept of the instant invention focuses on creating a soft tissue model but in a more precise, easy way, which is very assured, accurate and uniform in its manufacture. The technique requires a spacer means comprising a band, ring, or sleeve forming a soft collar slips over the analog and slides up to the base of the set impression material near the collar of the impression coping as it emerges through the impression. The spacer means now forms a uniform blockout around the impression coping which is recording the sub-gingival space over the top of the fixture. Analogic, also requires that the neck of the analog has a soft collar surrounding it so hard stone does not approach the top of the fixture analog where it couples with other components. This is done either with the same sleeve, band, or ring forming a collar surrounding the analog. This creates a precise channel to the implant fixture which has a soft liner than can be removed or replaced back, creating a set amount of relief around each channel, with a soft base surrounding the fixture analog itself. This eliminates the need of soft tissue models and allows easy accurate access to the fixture head deep in the model in a precise, reproducible manner.

There are other applications for the analogic device and its method of use. For instance, a dentist will place a restorative type abutment on the implant in the mouth and torque it so it will not loosen. Next, rather than take a fixture or implant level impression he or she will take an impression at the abutment level. The same fundamental principles apply; however, rather than utilizing an implant replica or fixture analog, the technician will simply use an abutment analog or replica. The method of forming a soft collar over the analog can be employed here as well. It can be used with all implant systems at the fixture or abutment levels.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is an oblique view of the impression coping held above the implant fixture (which is already in the patient's jawbone.

FIG. 2 is an oblique view of the impression coping screwed into the implant fixture with impression material held within an impression housing.

FIG. 3 is an oblique view showing the set impression wherein the transfer coping removed from the impression.

FIG. 4 is the implant fixture of FIG. 3 with a sleeve pressed onto the implant fixture and into place, the impression ready to be poured with stone material.

FIG. 5 shows the implant fixture of FIG. 4 surrounded in stone material covering the collar surrounding the end of the implant.

FIG. 6 is an oblique drawing of the poured stone impression removed from the impression of FIG. 5 with the coping removed and with a portion of the sleeve and implant analog exposed.

FIG. 7 is an oblique drawing of the poured stone impression as in FIG. 6 but with the sleeve removed.

FIG. 8 is an oblique drawing of an abutment secured in a patient's mouth.

FIG. 9 is an oblique drawing of a patient's mouth showing a permanently installed abutment.

FIG. 10 is an oblique drawing of a patient's mouth showing a permanently installed abutment with a snap-on impression cap snapped onto the abutment and ready to have an impression made.

FIG. 11 is a drawing of an abutment with snap-on impression cap.

FIG. 12 is an oblique view showing a spacer member ring or collar or sleeve having irregular and distinctly shaped outer peripheries disposed around the impression coping held above the implant fixture which is already in the patient's jawbone.

FIG. 13 shows an impression coping and fixture wherein the analogic soft collar spacer member is disposed below the ceralogic portion.

### DESCRIPTION OF THE PREFERRED EMBODIMENTS

In accordance with the present invention, there is provided a method of using a sleeve in place of painting on a soft rubbery material around the impression coping before pouring the dental stone in the impression.

An impression is made of the patients mouth as follows. An impression tray or housing 40 is filled with impression material 50 such as polyvinylsiloxane. The tray 50 is held in the patient's mouth covering the patient's teeth and gums until the impression 80 sets up. The impression 80 is removed showing the features of the patient's teeth and gum.

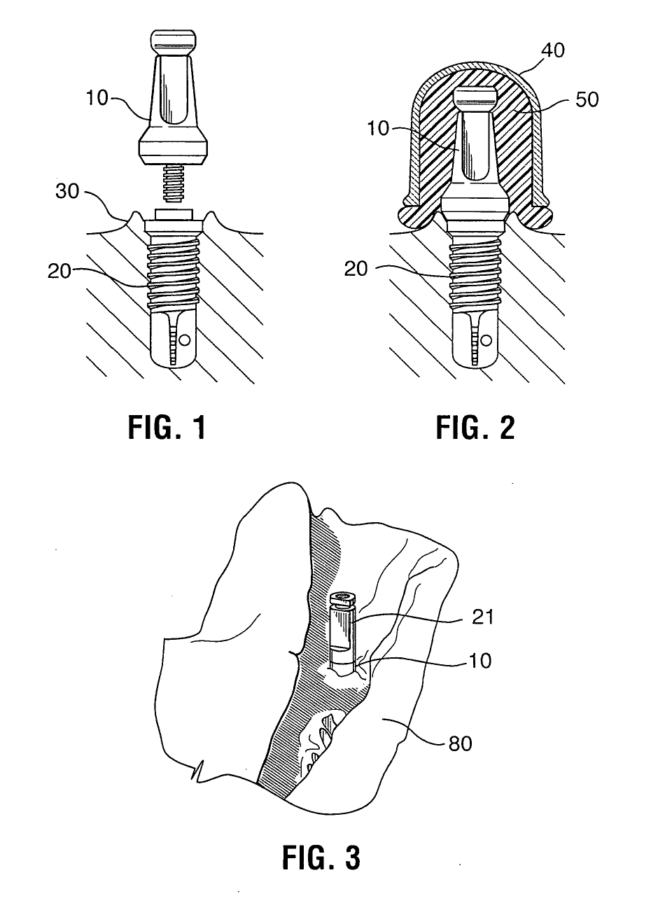

FIG. 1 shows an oblique view of the impression coping held above the implant fixture (which is already in the patient's jawbone. FIG. 2 shows the impression coping screwed into the implant fixture with impression material held within an impression housing. The set impression is illustrated in FIG. 3, wherein the transfer coping is removed from the impression and an implant analog is installed into an impression coping held within an impression.

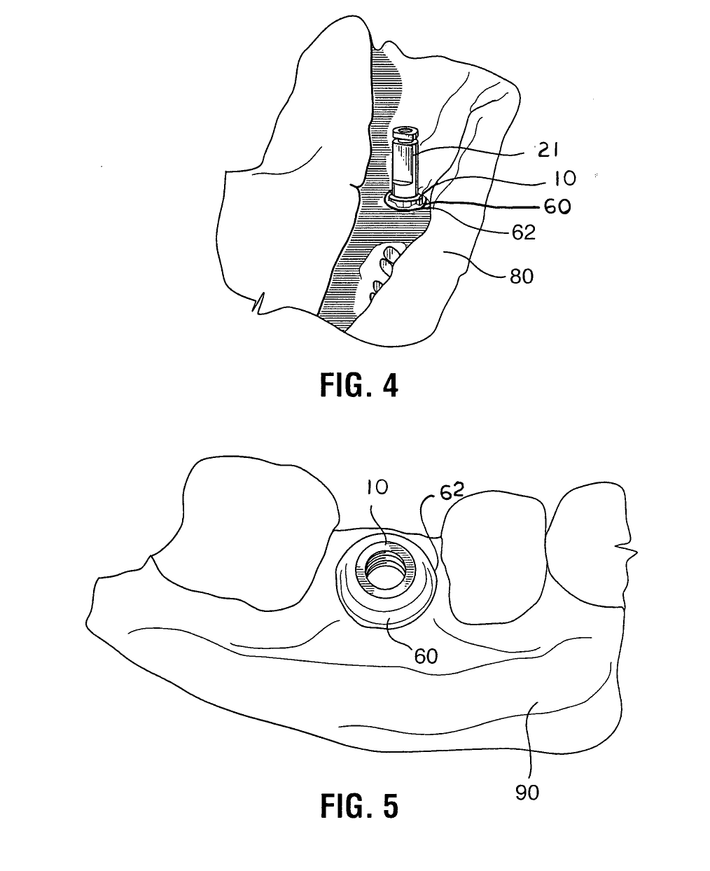

FIG. 4 shows the implant fixture of FIG. 3 with a sleeve pressed onto the implant fixture and into place, whereby the impression ready to be poured with stone material.

A technician now prepares the impression 80 for pouring with dental stone. The impression coping 10 is installed by attaching an implant analog 21 having a threaded end cooperatively engaging threads extending around the body or one end of an implant analog 21 screwed into the socket or hole left by the coping in the patient's mouth.

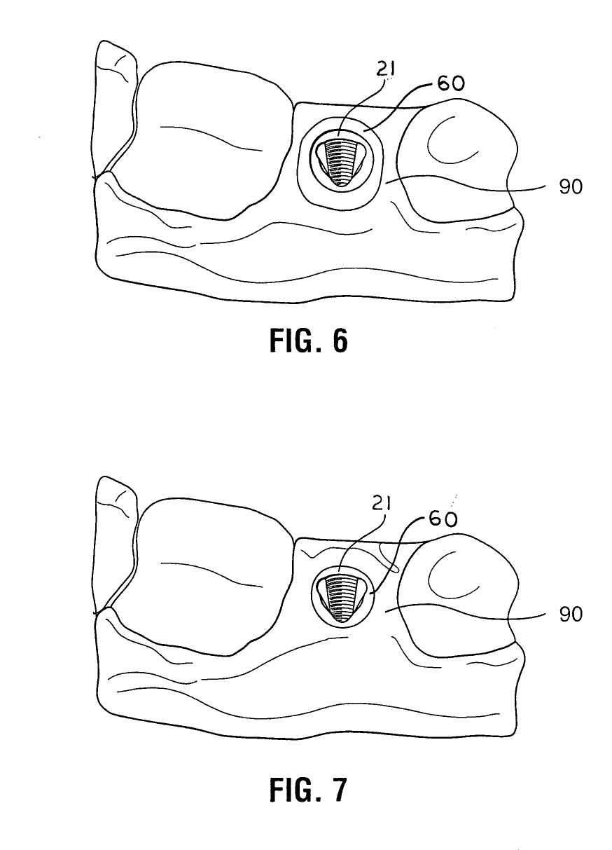

For instance in FIGS. 4-6, the implant analog 21 is shown screwed into the coping 10. Now, instead of painting a rubbery material around the base of the impression coping 10 (as is done in the conventional soft tissue modeling), he installs a sleeve or collar or ring 60 over the implant analog 21 and down against the impression material 62. Typically, the impression coping 10 protrudes out of the impression 80 so that when the implant 21 is screwed into it, the junction where the two come together should be covered with the sleeve 60 as shown in FIG. 4. FIG. 5 illustrate the implant analog with a sleeve 60 pushed onto it. The uneven area 62 of the impression is shown as well. It is possible for the sleeve to cover the junction of the impression coping and the fixture and/or abutment analog.

If the sleeve 60 is of the type which can be stiffened or cross-linked by irradiation, heat, or air curing, now is the time for the technician to do so in order to form an elastic or rubbery type of material having memory which will tend to retain its shape even if compressed or stretched after curing. (This will cause the sleeve 60 to record the uneven shape 62 which corresponds to the actual shape of the patients gums in that area enabling re-orientation of same). Now the technician pours the stone material to make the model 90.

The dental stone is allowed to set up and is then removed along with the coping 10. The implant analog 21 is contained in the model 90. The impression coping 10 can now be unscrewed from the implant analog 21. The sleeve 60 is still over the end of the implant analog 21 and flush with the surface of the model 90 as shown in FIG. 7. The sleeve 60 can now be removed, leaving a clearance in the stone around the implant analog 21. Now the technician can use the stone impression 90 with implant analog 21 contained therein to fabricate a dental implant (replacement tooth) using the stone impression as a model of the patient's mouth and taking advantage of the clearance within the model 90 left by the sleeve 60 or place it back into the model to reproduce the original gum contours for a test fit.

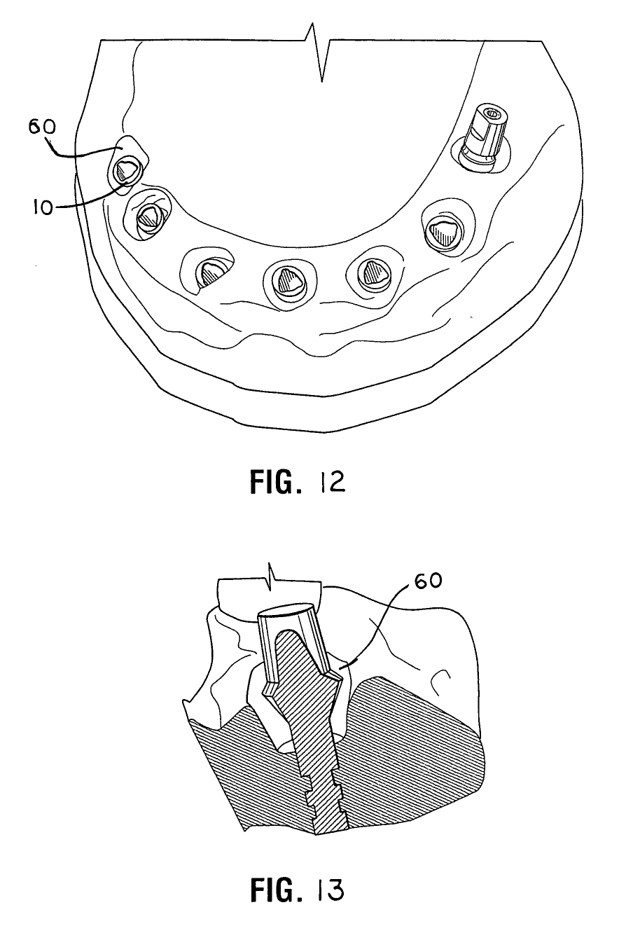

As best illustrated in FIG. 12, the sleeve 60 will have a circular inner wall but the outer wall may be ovoid, tear drop shaped or any non circular shape that will cause it to be placed back into the model in the same orientation as when the model was made. In this way, the technician has a record of the uneven gum shape.

Another key feature provided by the present invention is facilitating the accurate digitizing of the stone impression and therefore the representation of the patients dental situation.

Another use for these soft collar spacing means is for scanning models of implant cases in order to digitize the models. With this technique the best scenario is prior to pouring the model, slide the analogic collar over the analog as previously described, but instead of pushing it all the way to the junction of the impression material leave it short about 1 mm from meeting the impression. Then after pouring there will be a stone or plaster collar surrounding the fixture or abutment analog. The model can be scanned at this point. Following the first scan, the stone can be easily removed above the analogic collar, the collar removed, and a second scan performed accurately recording the fixture or abutment position. This then enables the CAD software to reassemble the model digitally. A perfect precise digital representation of the patient's situation, recorded in an easy way.

More particularly, the method for scanning and digitizing dental models utilizes the following steps: preparing the patient with an implant fixture 20 in the jaw bone and allowing healing; installing an impression coping 10 in the fixture in the patient's mouth; making an impression 80 of the patient's mouth; removing the impression 80; installing the impression coping 10 with an abutment analog 21 screwed into it; installing a sleeve 60 over the implant analog and down to the impression material; pouring dental stone into the impression 80; removing the dental model 90 from the impression 80 along with the coping 10 now exposed ; removing said impression coping 10; optionally performing a digital scan of the stone impression; removing the stone material covering the sleeve 60; and if desired, performing a second digital scan recording the fixture position within the stone impression.

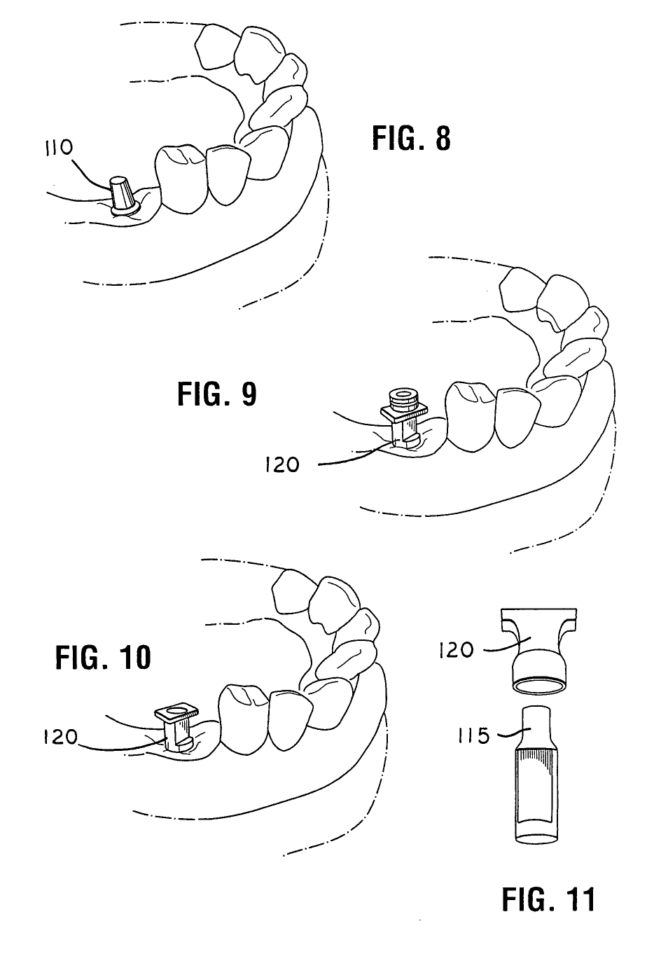

An alternate embodiment of the process of making a dental stone model using a restorative abutment method can be understood by referring to FIGS. 8-11. FIGS. 9 and 11 shows a restorative abutment 120 permanently installed in a mouth. FIG. 10 shows a snap-on impression cap 120 snapped onto the restorative abutment 110 as shown in FIG. 8.

An impression 80 is prepared and upon removal, the snap-on impression cap 120 snaps off of the abutment 110 and remains in the impression 80. Now the technician snaps an abutment analog 115 (replica) into the snap-on impression cap 120 held within the impression 80. At this point, he installs a sleeve over the abutment and down against the impression material as before. If he is using a sleeve which can be stiffened using irradiated energy, he does so. The rest of the procedure is as above.

The soft collar spacing means of the instant invention can also be used in ceralogic applications wherein the diameter of the impression coping is over-sized so that when the plaster or stone is poured in the impression model the channel is automatically oversized. Use of an analogic analog with an ring or sleeve at its neck where it attaches to the fixture. This method involves over sizing the healing abutments and any temporary abutments as well. This creates a soft collar surrounding the fixture replica and an oversized channel to the fixture.

These components can be made of numerous types of polymers, typically thermoplastics having flexibility and stretching capabilities, but it is advantageous to utilize soft polymers having elasticity such as silicones, elastomers, and plastisols. Plastisols are dispersions of extremely fine particles of high molecular weight polyvinyl chloride resin and additives in liquid plasticizers. Hot melt plastisols can be manufactured in a range of hardness and with a variety of properties, including density, clarity and heat resistance and can be formed from food grade, phthalate free and medical grade polymers. Hot melts can be processed with a variety of different equipment including microwave, infrared, quartz tube, convection oven, UV radiation, and injection molding.

Polyurethane elastomers are two part polyurethane used to mold a wide variety of products. They are available in a virtually limitless range of physical and chemical characteristics, including light stable aliphatic polyurethane.

The present soft collar spacing means and method of use provides improved communication between the dentist and technician. The method simply streamlines the entire fabrication process.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

We claim:

1. A method for fabricating a replacement tooth comprising:
preparing the patient with an implant fixture in the bone and allowing healing;
installing a first impression coping in the fixture in the patients mouth;
making an impression of the patient's mouth;
removing said impression from the patient's mouth;
installing a second impression coping with an implant analog screwed into it into a hole in said impression left by said first impression coping in said patient's mouth;
installing a sleeve over said implant analog and down against said impression material;
pouring dental stone into said impression to make a model;
removing said model from said impression along with said second impression coping now exposed;
removing said second impression coping from said implant analog;
removing said sleeve from said implant analog;
installing an abutment into said implant analog; and
forming a replacement tooth onto said abutment while using, removing, test fitting and reinstalling said sleeve as needed during fabrication of said replacement tooth.

2. A method for fabricating a replacement tooth comprising:
preparing the patient with an implant analog in the bone and allowing healing;
installing and permanently torquing an abutment in said implant analog in the patients mouth;
making an impression of the patient's mouth;
removing said impression from the patient's mouth;
installing an abutment analog with an implant analog screwed into it into a hole in said impression left by said abutment in said patient's mouth;
installing a sleeve over said implant analog and down against said impression material;
pouring dental stone into said impression to make a model;
removing said model from said impression along with said abutment analog now exposed;
removing said abutment analog from said implant analog;
removing said sleeve from said implant analog;
installing said abutment analog into said implant analog; and
forming a replacement tooth onto said abutment while using, removing, test fitting and reinstalling said sleeve as needed during fabrication of said replacement tooth.

3. A method for scanning and digitizing dental models comprising:
preparing the patient with an implant fixture in the bone and allowing healing;
installing an impression coping in the fixture in the patients mouth;
making an impression of the patient's mouth;
installing said impression coping with an implant analog screwed into it;
installing a sleeve over said implant analog and down to 1 millimeter above said impression material for the purpose of allowing a 1 millimeter skin of dental stone to form over said sleeve;
pouring dental stone into said impression to form a model;
removing said model from said impression along with said coping now exposed;
removing said impression coping;
performing a digital scan of said stone impression;
removing 1 millimeter of stone material covering said sleeve; and
performing a second digital scan recording said fixture position within said stone impression.
